(19) United States
(12) Patent Application Publication
(10) Pub. No.: US 2009/0302116 A1
(43) Pub. Date: Dec. 10, 2009

(54) SEMI-ZOOM IMAGING OPTICAL SYSTEM

(75) Inventors: Chinh TAN, Setauket, NY (US); David Tsi Shi, Stony Brook, NY (US); Igor Vinogradov, New York, NY (US); Ming Yu, South Setauket, NY (US)

Correspondence Address: SYMBOL TECHNOLOGIES INC / MOTOROLA, INC, ONE MOTOROLA PLAZA, A-6, HOLTSVILLE, NY, 11742, US

(73) Assignee: Symbol Technologies, Inc., Holtsville, NY (US)

(21) Appl. No.: 12/132,753

(22) Filed: Jun. 4, 2008

(51) Int. Cl. G06K 7/00

(52) U.S. Cl. 235/462.35

(57) ABSTRACT

An apparatus includes a first lens, a liquid lens, imaging sensor arrays, an aperture stop, and a barcode decoding system. The first lens has a fixed optical power. The liquid lens has a variable optical power. The imaging sensor arrays are operable to receive light passing through both the first lens and the liquid lens. The liquid lens is positioned between the aperture stop and the imaging sensor arrays. The barcode decoding system receives signals from the imaging sensor arrays.

### FIELD OF THE DISCLOSURE

The present disclosure relates generally to optical systems.

### BACKGROUND

Various electro-optical systems have been developed for reading optical indicia, such as barcodes. A barcode is a coded pattern of graphical indicia comprised of a series of bars and spaces of varying widths, the bars and spaces having differing light reflecting characteristics. Some of the more popular barcode symbologies include: Universal Product Code (UPC), typically used in retail stores sales; Data Matrix, typically used for labeling small electronic products; Code 39, primarily used in inventory tracking; and Postnet, which is used for encoding zip codes for U.S. mail. Barcodes may be one dimensional, i.e., a single row of graphical indicia such as a UPC barcode or two dimensional, i.e., multiple rows of graphical indicia comprising a single barcode, such as Data Matrix which comprising multiple rows and columns of black and white square modules arranged in a square or rectangular pattern.

Systems that read barcodes (i.e., barcode readers) electro-optically transform the graphic indicia into electrical signals, which are decoded into alphanumerical characters that are intended to be descriptive of the article or some characteristic thereof. The characters are then typically represented in digital form and utilized as an input to a data processing system for various end-user applications such as point-of-sale processing, inventory control and the like.

Barcode readers that read and decode barcodes employing imaging systems are typically referred to as imaging-based barcode readers or barcode scanners. Imaging systems include charge coupled device (CCD) arrays, complementary metal oxide semiconductor (CMOS) arrays, or other imaging sensor arrays having a plurality of photosensitive elements (e.g., photo-sensors) defining image pixels. For example, the plurality of photosensitive elements can be arranged in the form of a matrix. An illumination system including light emitting diodes or other light source directs illumination light toward a target barcode, e.g., a target barcode. Light reflected from the target barcode is focused through a system of one or more lens of the imaging system onto the sensor array. Periodically, the pixels of the sensor array are read out to generate signal representative of a captured image frame, which can be processed by the decoding circuitry of the imaging system to decode the imaged barcode. In some barcode readers, light reflected from the target barcode is focused onto the imaging sensor arrays though an autofocus optical system.

FIGS. 1A and 1B illustrate a simplified autofocus optical system that uses a mechanical means to change the distance between the optical lens and the imaging sensor arrays in order to keep the image in focus. In FIGS. 1A and 1B, the autofocus optical system include a lens 40 (or a lens group), imaging sensor arrays 60, and some mechanical means (not shown in the figure) to change the distance between the lens 40 and the imaging sensor arrays 60. As shown in FIG. 1A, light 20 originated from a barcode at a far away distance will be focused at a plane 25 that is at a distance f₀ from the lens 40, where f₀ is the focus length of the lens 40. As shown in FIG. 1B, light 30 originated from a barcode at a nearby distance x+f₀ from the lens 40 will be focused at a plane 35 that is at a distance f₀+f₀²/x from the lens 40, rendering the imaging at the sensor arrays 60 at plane 25 out of focus. In operation, some mechanical means (not shown in the figure) will adjust the distance between the lens 40 and the imaging sensor arrays 60 by repositioning the lens 40 to ensure a sharp image is formed on the sensor arrays 60. in order to position the imaging sensor arrays 60 at the plane (e.g., the plane 25 or the plane 35) where the image of a barcode is formed.

In FIG. 1A, if the imaging sensor arrays 60 have a dimension 2 D, t hen, the sensor field of view 46A is proportional to D/f₀. In FIG. 1B, if the imaging sensor arrays 60 has a dimension 2D, then, the sensor field of view 46B is proportional to D/(f₀+f₀²/x). FIGS. 1A and 1B illustrate that, the sensor field of view decrease as a barcode moves closer to the optical system. For a barcode imager, however, it maybe preferred to increase the sensor field of view as a barcode target moves closer to the optical system. More specifically, when the barcode target is close to the imager, it maybe preferred to increase the sensor field of view to cover the complete target; and when the barcode target is far way from the imager, it maybe preferred to reduce the sensor field of view to increase the resolution limit of the imager.

Accordingly, there is a need for an optical system that can increase the sensor field of view when a target barcode moves closer to the optical system, and reduce the field of view to read faraway target barcodes

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIGS. 1A and 1B illustrate a simplified autofocus optical system that uses a mechanical means to change the distance between the optical lens and the imaging sensor arrays in order to keep the image in focus.

FIGS. 2A and 2B illustrate implementations of an optical system that includes a liquid lens having a variable optical power.

FIGS. 3A and 3B illustrate how the sensor field of view changes when a target barcode moves closer to an optical system.

FIGS. 4A-4C illustrate several implementations of the optical system 100 for using in automatic data capture system for capturing barcodes.

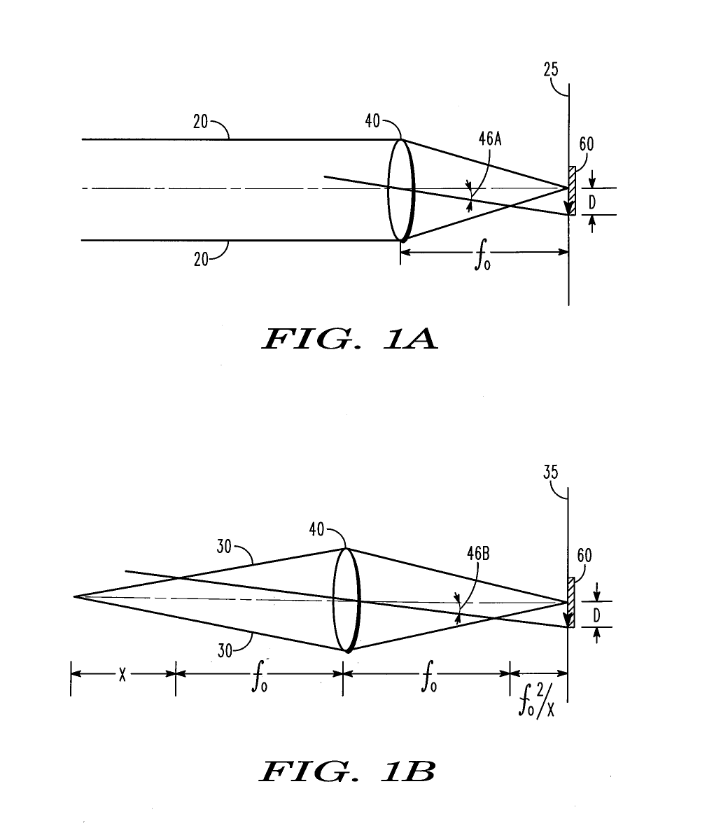

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### SUMMARY

In one aspect, the invention is directed to an apparatus. The apparatus includes a first lens, a liquid lens, imaging sensor arrays, an aperture stop, and a barcode decoding system. The first lens has a fixed optical power. The liquid lens has a variable optical power. The imaging sensor arrays are operable to receive light passing through both the first lens and the liquid lens. The liquid lens is positioned between the aperture stop and the imaging sensor arrays. The barcode decoding system receives signals from the imaging sensor arrays.

### DETAILED DESCRIPTION

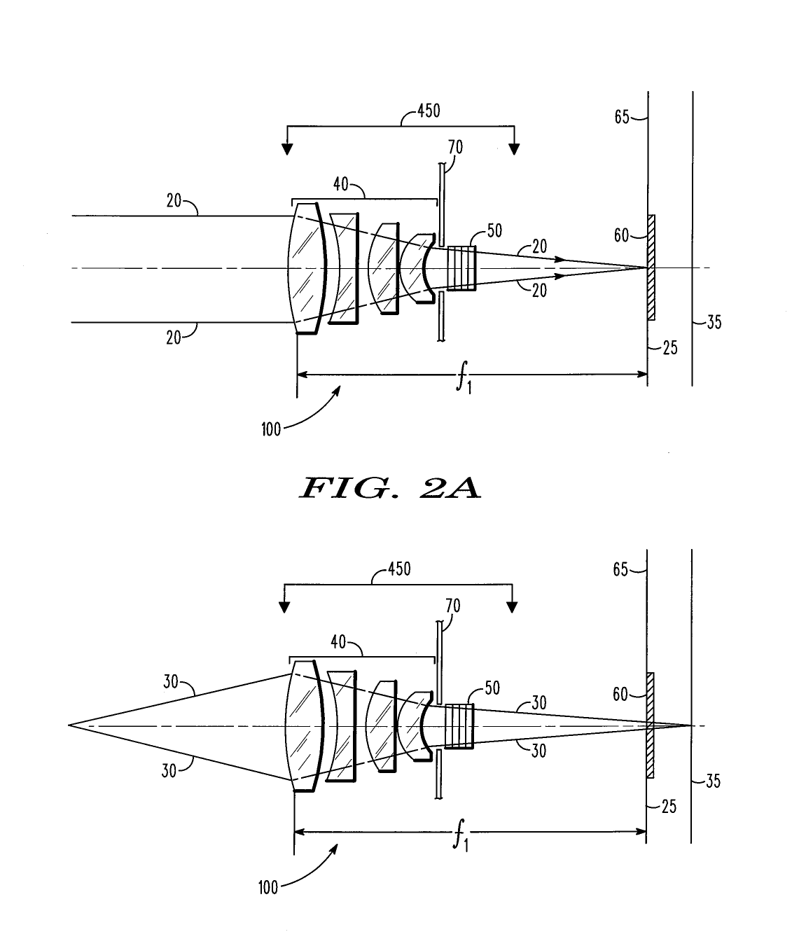

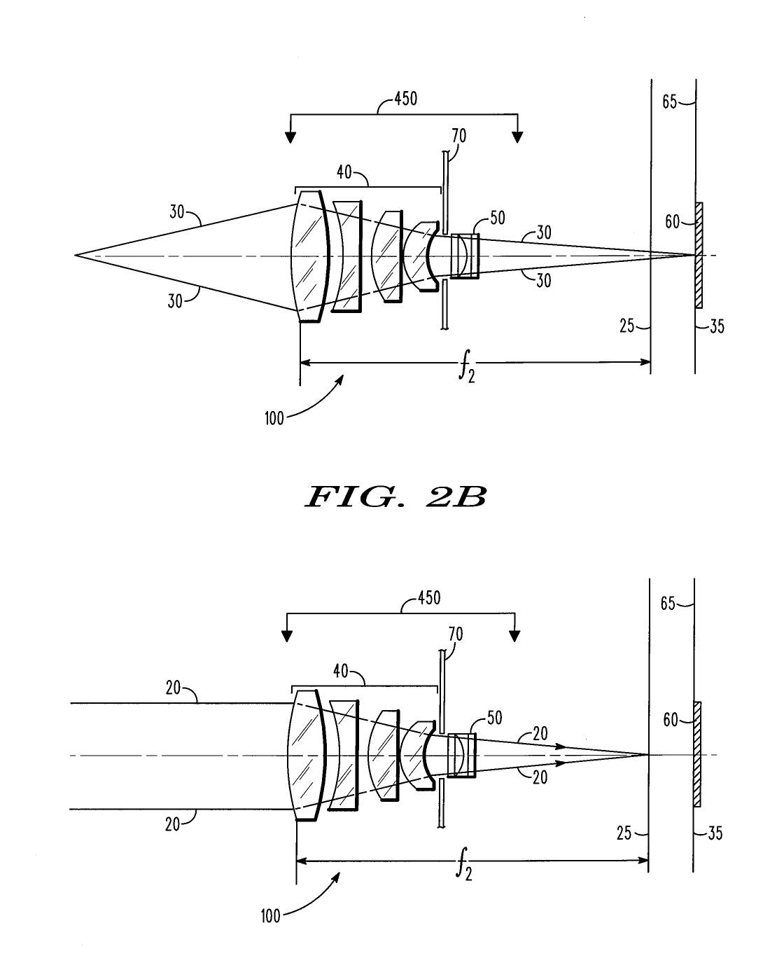

FIGS. 2A and 2B illustrate implementations of an optical system 100 that includes a liquid lens having a variable optical power. In FIGS. 2A and 2B, an optical system 100 includes a first lens 40 having a fixed optical power, a liquid lens 50 having a variable optical power, imaging sensor arrays 60, and an aperture stop 70. The imaging sensor arrays 60 receives light passing through both the first lens 40 and the liquid lens 50. The liquid lens 50 is positioned between the aperture stop 70 and the imaging sensor arrays 60.

The first lens 40 can be a simple lens or a compound lens including a group of lenses as shown in the figure. In one implementation, as shown in FIGS. 2A and 2B, the liquid lens 50 is positioned between the first lens 40 and the imaging sensor arrays 60. In other implementations, the first lens 40 can be positioned between the liquid lens 50 and the imaging sensor arrays 60. The liquid lens 50 can include one or more electrode for controlling the variable optical power of the liquid lens.

In operation, the focus length of a lens system 450, which includes the first lens 40 and the liquid lens 50, can be adjusted by changing the optical power of the liquid lens 50. In FIG.2A, the liquid lens 50 has near zero optical power, and the effective focus length of the lens system 450 is f₁. As shown in the upper figure of FIG. 2A, light 20 originated from a barcode at a far away distance will be focused at an infinite conjugate focus plane 25 which can be identical to the plane 65 on which the imaging sensor arrays 60 is positioned. As shown in the lower figure of FIG. 2A, light 30 originated from a barcode at some nearby distance will be focused at a finite conjugate focus plane 35 that is at a distance from the plane 65 on which the imaging sensor arrays 60 is positioned; this nearby barcode may not be effectively resolved by the imaging sensor arrays 60 with good resolution. On the other hand, this nearby barcode can be brought into focus by adjusting the optical power of the liquid lens 50. As shown in the upper figure of FIG. 2B, when the liquid lens 50 is changed to certain positive optical power, light 30 originated from the nearby barcode is now focused at a finite conjugate focus plane 35 which can be identical to the plane 65 on which the imaging sensor arrays 60 is positioned. It is now possible to have this local barcode effectively resolved by the imaging sensor arrays 60 with good resolution without changing the distance between the imaging sensor arrays 60 and the liquid lens 50. It should be noticed that, in the lower figure of FIG. 2B, light 20 originated from a far away barcode is now focused at an infinite conjugate focus plane 25 that is at a distance from the plane 65 on which the imaging sensor arrays 60 is positioned; this far away barcode may not be effectively resolved by the imaging sensor arrays 60 with good resolution. In addition, in FIG. 2B, when the liquid lens 50 has certain positive optical power, the effective focus length of the lens system 450 is changed to f₂, which is smaller than f₁, the effective focus length in FIG. 2A.

In FIGS. 2A and 2B, the liquid lens 50 is positioned between the aperture stop 70 and the imaging sensor arrays 60, and such configuration has some advantages when used in certain apparatus, such as, barcode imagers. More specifically, when the optical system 100 is used in a barcode imager, it may be advantageous to increase the sensor field of view as a target barcode moves closer to the optical system. This optical system 100 maybe used in automatic data capture systems and other systems for capturing images, documents, or pictures. When the optical system 100 is used in an automatic data capture system for capturing barcodes, light detected by the imaging sensor arrays 60 can be converted to electrical signals and such electrical signals can be coupled into a barcode decoding system for decoding barcode information.

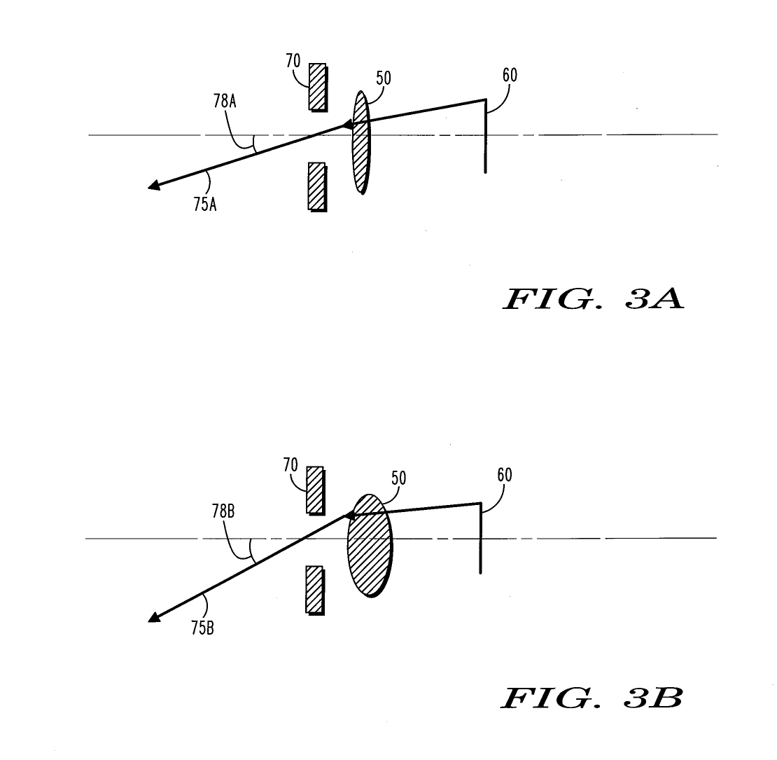

FIGS. 3A and 3B illustrate how the sensor field of view changes when a target barcode moves closer to an optical system in which the liquid lens 50 is positioned between the aperture stop 70 and the imaging sensor arrays 60. The liquid lens 50 in FIG. 3A has an optical power that is smaller than the optical power of the liquid lens 50 in FIG. 3B. In FIG. 3A, the chief ray 75A passing the center of the aperture stop 70 is shown in the figure and the angle 78A may determine the sensor field of view of the optical system 100. In FIG. 3B, the liquid lens 50 has a large positive optical power to enable the optical system 100 to image nearby barcode. The chief ray 75B passing the center of the aperture stop 70 is shown in the figure and the angle 78B may determine the sensor field of view of the optical system 100. Because the liquid lens 50 in FIG. 3B has larger optical power than liquid lens 50 in FIG. 3A, the chief ray 75B in FIG. 3B has been bended more significantly than the chief ray 75A in FIG. 3A has been bended. It follows that the angle 78B in FIG. 3B is significantly larger than the angle 78A in FIG. 3A. Therefore, the sensor field of view of the optical system 100 increases when a target barcode moves closer to the optical system.

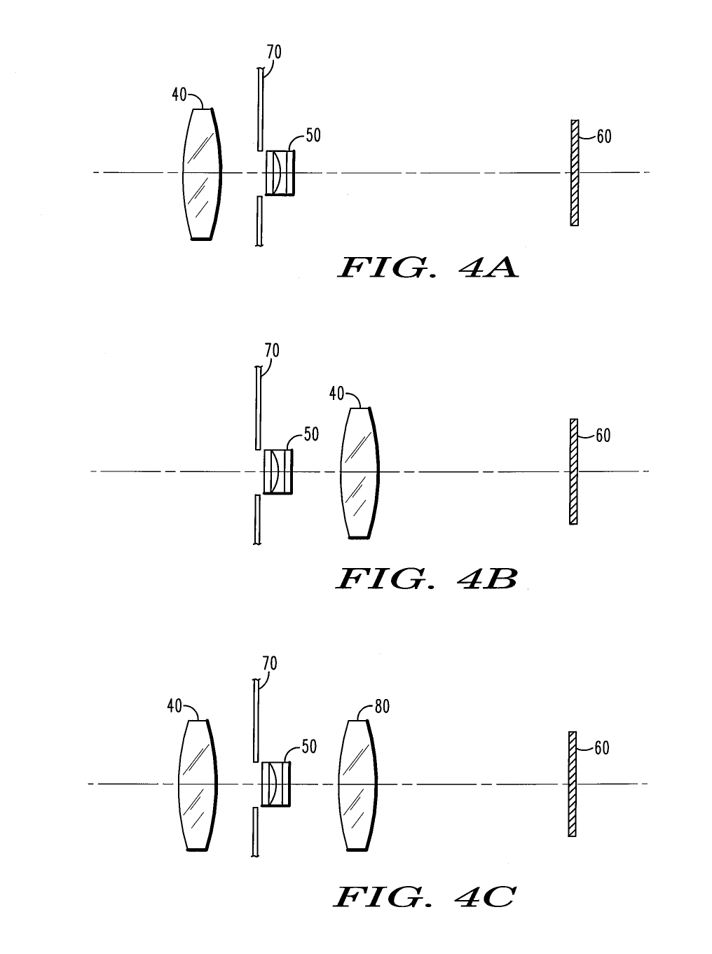

FIGS. 4A-4C illustrate several implementations of the optical system 100 for using in automatic data capture system for capturing barcodes. In FIGS. FIGS. 4A-4C, the optical system 100 includes a first lens 40 having a fixed optical power, a liquid lens 50 having a variable optical power, imaging sensor arrays 60, and an aperture stop 70. The liquid lens 50 is positioned between the aperture stop 70 and the imaging sensor arrays 60. In FIG. 4A, the liquid lens is positioned between the first lens and the imaging sensor arrays. In FIG. 4B, the first lens is positioned between the liquid lens and the imaging sensor arrays. In FIG. 4C, the optical system 100 further includes a second lens having a fixed optical power, and the liquid lens is positioned between the first lens and the second. In these implementations, the first lens 40 can be a simple lens or a compound lens; the second lens 80 can also be a simple lens or a compound lens.

In some implementations, the optical system 100 can be installed in a barcode reader directly. In other implementations, the optical system 100 can be installed in a scan engine. The scan engine can be installed in a barcode reader. The barcode reader can be a stationary barcode reader or a portable barcode reader.

There are many different implementations of liquid lenses that can have variable focus lengths and fast response time. Some implementations are described in U.S. Pat. No. 6,369,954, titled “Lens with Variable Focus.” In some implementations, a liquid lens includes a chamber filled with a first liquid, a drop of a second liquid being disposed at rest on a region of a first surface of an insulating wall of the chamber. The first and second liquids are non miscible, of different optical indexes and of substantially same density. The first liquid is conductive. The second liquid is insulating. In operation, when a voltage is applied between the conductor liquid and an electrode placed on the second surface of the insulating wall, the focus length of the liquid lens can be changed.

In some implementation of the optical system 100, the liquid lens 50 can be substituted with other kinds of variable lens that includes at least one electrode for varying its optical power. For example, such a variable lens can be a variable liquid crystal lens. Some implementations of variable liquid crystal lenses are described in U.S. Pat. No. 4,190,330, U.S. Pat. No. 5,305,731, and U.S. Pat. No. 6,859,333. In one implementation, a variable liquid crystal lens includes a pair of light-transmissive, electrically conductive electrodes and a nematic liquid crystal layer between the electrodes. The liquid crystal layer has a changeable optical index of refraction. A voltage applied across the electrodes will change the index of refraction of the liquid crystal layer, which results in changes in the focus lens of the liquid crystal lens.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. An apparatus comprising:
a first lens having a fixed optical power;
a liquid lens having a variable optical power;
imaging sensor arrays operable to receive light passing through both the first lens and the liquid lens;
an aperture stop, wherein the liquid lens is positioned between the aperture stop and the imaging sensor arrays; and
a barcode decoding system receiving signals from the imaging sensor arrays.

2. The apparatus of claim 1, wherein the liquid lens comprises:
an electrode for controlling the variable optical power of the liquid lens.

3. The apparatus of claim 1, wherein the liquid lens is positioned between the first lens and the imaging sensor arrays.

4. The apparatus of claim 1, wherein the first lens is positioned between the liquid lens and the imaging sensor arrays.

5. The apparatus of claim 1, wherein the first lens is a simple lens.

6. The apparatus of claim 1, wherein the first lens is a compound lens including a group of lenses.

7. The apparatus of claim 1, further comprising:
a second lens having a fixed optical power.

8. The apparatus of claim 7, wherein:
the liquid lens is positioned between the first lens and the second lens.

9. The apparatus of claim 7, wherein the second lens is a simple lens.

10. The apparatus of claim 7, wherein the second lens is a compound lens including a group of lenses.

11. An apparatus comprising:
a first lens having a fixed optical power;
a variable lens having an electrode for varying the optical power thereof;
imaging sensor arrays operable to receive light passing through both the first lens and the variable lens;
an aperture stop, wherein the variable lens is positioned between the aperture stop and the imaging sensor arrays; and
a barcode decoding system receiving signals from the imaging sensor arrays.

12. The apparatus of claim 11, wherein the variable lens is positioned between the first lens and the imaging sensor arrays.

13. The apparatus of claim 11, wherein the first lens is positioned between the variable lens and the imaging sensor arrays.

14. The apparatus of claim 11, wherein the first lens is a simple lens.

15. The apparatus of claim 11, wherein the first lens is a compound lens including a group of lenses.

16. The apparatus of claim 11, further comprising:
a second lens having a fixed optical power.

17. The apparatus of claim 16, wherein:
the variable lens is positioned between the first lens and the second lens.

18. The apparatus of claim 16, wherein the second lens is a simple lens.

19. The apparatus of claim 16, wherein the second lens is a compound lens including a group of lenses.

20. An apparatus comprising:
a first lens having a fixed optical power;
a variable lens having an electrode for varying the optical power thereof;
imaging sensor arrays operable to receive light passing through both the first lens and the liquid lens; and
an aperture stop, wherein the variable lens is positioned between the aperture stop and the imaging sensor arrays.

21. The apparatus of claim 20, further comprising:
a scan engine chassis having the first lens, the variable lens, and the imaging sensor arrays, and the aperture stop installed therein.

22. The apparatus of claim 20, further comprising:
a portable enclosure having the scan engine chassis installed therein.

23. The apparatus of claim 20, further comprising:
a stationary enclosure having the scan engine chassis installed therein.

24. The apparatus of claim 20, further comprising:
a portable enclosure having the first lens, the variable lens, and the imaging sensor arrays, and the aperture stop mounted therein installed therein.

25. The apparatus of claim 20, further comprising:
a stationary enclosure having the first lens, the variable lens, and the imaging sensor arrays, and the aperture stop installed therein.
